(19) United States
(12) Patent Application Publication
(10) Pub. No.: US 2025/0294578 A1
(43) Pub. Date: Sep. 18, 2025

(54) TECHNIQUES FOR RADIO LINK CONTROL ACKNOWLEDGMENT MODE RETRANSMISSIONS

(71) Applicant: QUALCOMM Incorporated, San Diego, CA (US)

(72) Inventors: Sherif ELAZZOUNI, San Diego, CA (US); Sitaramanjaneyulu KANAMARLAPUDI, San Diego, CA (US); Ozcan OZTURK, San Diego, CA (US)

(21) Appl. No.: 18/606,933

(22) Filed: Mar. 15, 2024

(51) Int. Cl. H04W 72/232; H04L 1/08; H04L 1/1812; H04W 72/1268

(52) U.S. Cl. CPC H04W 72/232; H04L 1/08; H04L 1/1812; H04W 72/1268

(57) ABSTRACT

Methods, systems, and devices for wireless communications are described. Techniques described herein provide for radio link control (RLC) acknowledgment mode (AM) retransmissions. In some examples, a user equipment (UE) may receive control signaling that indicates a configuration for a scheduling request. The configuration may indicate the scheduling request is to report an availability of retransmission traffic currently available for transmission. The UE may transmit the scheduling request indicating the availability of retransmission traffic based on the configuration. The UE may receive a grant for a portion of the retransmission traffic responsive to the scheduling request, and the UE may transmit the portion of the retransmission traffic based on the grant.

### FIELD OF TECHNOLOGY

The following relates to wireless communications, including techniques for radio link control acknowledgment mode retransmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for radio link control (RLC) acknowledgment mode (AM) retransmissions. For example, the described techniques may provide a separate scheduling request configuration for RLC packet data unit (PDU) retransmissions. In some examples, the UE may receive control signaling that indicates a configuration for a scheduling request. The configuration may indicate that the scheduling request is to report an availability of retransmission traffic currently available for transmission. The UE may transmit the scheduling request indicating the availability of retransmission traffic based on the configuration. The UE may receive a grant for a portion of the retransmission traffic responsive to the scheduling request, and the UE may transmit the portion of the retransmission traffic based on the grant.

A UE for wireless communication is described. The UE may include one or more memories storing processor executable code, and one or more processors coupled with the one or more memories. The one or more processors may individually or collectively be operable to execute the code to cause the UE to receive first control signaling that indicates a first configuration for a first scheduling request, the first configuration indicating the first scheduling request is to report an availability of retransmission traffic currently available for transmission, transmit the first scheduling request indicating the availability of retransmission traffic based on the first configuration, receive a first grant for at least a first portion of the retransmission traffic responsive to the first scheduling request, and transmit the first portion of the retransmission traffic based on the first grant.

### BRIEF DESCRIPTION OF THE DRAWINGS

FIG. 1 shows an example of a wireless communications system that supports techniques for radio link control acknowledgment mode (RLC AM) retransmissions in accordance with one or more aspects of the present disclosure.

FIG. 2 shows an example of a wireless communications system that supports techniques for RLC AM retransmissions in accordance with one or more aspects of the present disclosure.

FIG. 3 shows examples of block diagrams that support techniques for RLC AM retransmissions in accordance with one or more aspects of the present disclosure.

FIG. 4 shows examples of block diagrams that support techniques for RLC AM retransmissions in accordance with one or more aspects of the present disclosure.

FIG. 5 shows an example of a block diagram that supports techniques for RLC AM retransmissions in accordance with one or more aspects of the present disclosure.

FIG. 6 shows an example of a process flow that supports techniques for RLC AM retransmissions in accordance with one or more aspects of the present disclosure.

FIGS. 7 and 8 show block diagrams of devices that support techniques for RLC AM retransmissions in accordance with one or more aspects of the present disclosure.

FIG. 9 shows a block diagram of a communications manager that supports techniques for RLC AM retransmissions in accordance with one or more aspects of the present disclosure.

FIG. 10 shows a diagram of a system including a device that supports techniques for RLC AM retransmissions in accordance with one or more aspects of the present disclosure.

FIGS. 11 and 12 show flowcharts illustrating methods that support techniques for RLC AM retransmissions in accordance with one or more aspects of the present disclosure.

### DETAILED DESCRIPTION

Some wireless communications system may deploy a network entity and a user equipment (UE). In some examples, the UE may operate in a radio link control (RLC) acknowledged mode (AM) when communicating with the network entity. In the RLC AM mode, the UE may transmit one or more RLC packet data units (PDUs) to the network entity, and the UE may store a copy of each of the transmitted RLC PDUs in a retransmission buffer. For each transmission of a RLC PDU, the UE may expect to receive a hybrid automatic repeat request (HARQ) acknowledgment (ACK) feedback or a negative acknowledgment (NACK) feedback from the network entity. If the UE receives ACK feedback, the RLC PDU in the retransmission buffer may be discarded. If the UE receives NACK feedback or no response, the RLC PDU in the retransmission buffer may be retransmitted to the network entity. In some cases, the UE may have transmitted several RLC PDUs to the network entity and may wait to receive the ACK or NACK feedback. In some examples, the UE may have several RLC PDUs to retransmit to the network entity, and the UE may wait to receive scheduling grants for the retransmission of the RLC PDUs.

Techniques for RLC AM retransmission may reduce latency. For example, a separate scheduling request configuration for RLC PDU retransmissions may reduce latency. In some examples, the UE may receive control signaling that indicates a configuration for a scheduling request. The configuration may indicate the scheduling request is to report an availability of retransmission traffic currently available for transmission. The UE may transmit the scheduling request indicating the availability of retransmission traffic based on the configuration. The UE may receive a grant for a portion of the retransmission traffic responsive to the scheduling request, and the UE may transmit the portion of the retransmission traffic based on the grant. In some examples, the scheduling request may be transmitted based on one or more of a duration that the retransmission traffic has been waiting for retransmission, a quantity of unsuccessful transmissions associated with the retransmission traffic, or a quantity of unsuccessful HARQ feedbacks associated with the retransmission traffic. In some examples, the UE may receive control signaling that indicates a buffer status report configuration. The buffer status report configuration may indicate that a buffer status report is to include one or more of a duration that the retransmission traffic has been waiting for retransmission, a HARQ identifier or identification associated with the retransmission traffic, or a logical channel group associated with the retransmission traffic.

Aspects of the disclosure are initially described in the context of wireless communications systems. Aspects of the disclosure are also described in context of block diagrams and a process flow. Aspects of the disclosure are further illustrated by and described with reference to apparatus diagrams, system diagrams, and flowcharts that relate to techniques for RLC AM retransmissions.

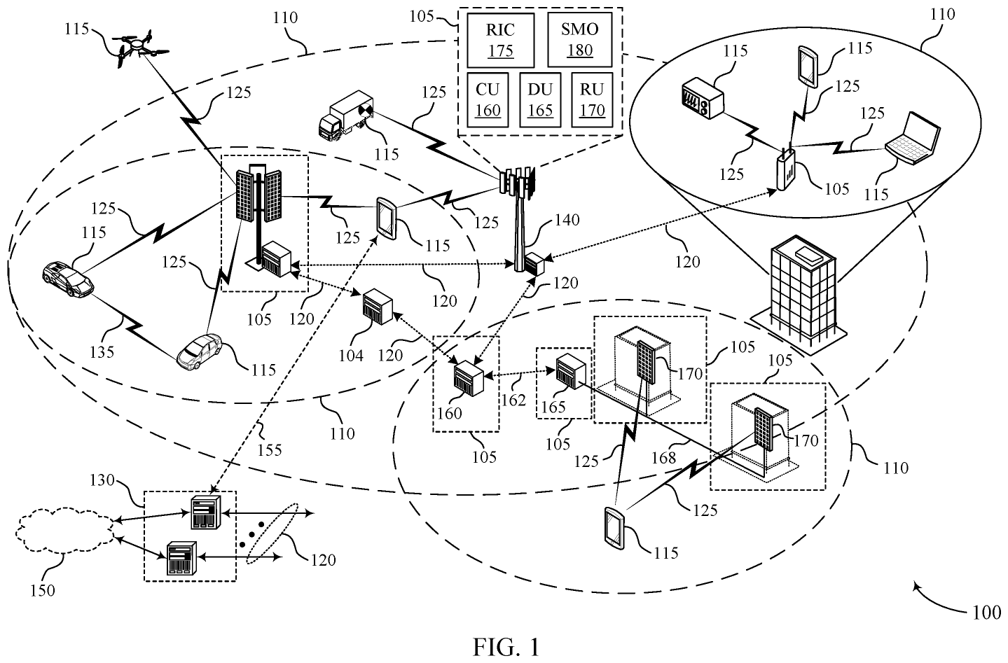

FIG. 1 shows an example of a wireless communications system 100 that supports techniques for RLC AM retransmissions in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless

communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communications system may deploy the network entity 105 and the UE 115. In some examples, the UE 115 may operate in a RLC AM when communicating with the network entity 105. In the RLC AM mode, the UE 115 may transmit one or more RLC PDUs to the network entity 105, and the UE 115 may store a copy of each of the transmitted RLC PDUs in a retransmission buffer. For each transmission of a RLC PDU, the UE 115 may expect to receive an ACK feedback or a NACK feedback from the network entity 105. If the UE 115 receives ACK feedback, the RLC PDU in the retransmission buffer may be discarded. If the UE 115 receives NACK feedback or no response, the RLC PDU in the retransmission buffer may be retransmitted to the network entity 105. In some cases, the UE 115 may have transmitted several RLC PDUs to the network entity 105 and may wait to receive the ACK or NACK feedback. In some examples, the UE 115 may have several RLC PDUs to retransmit to the network entity 105, and the UE 115 may wait to receive scheduling grants for the retransmission of the RLC PDUs.

Techniques for RLC AM retransmission may reduce latency. For example, a separate scheduling request configuration for RLC PDU retransmissions may reduce latency. In some examples, the UE 115 may receive control signaling that indicates a configuration for a scheduling request. The configuration may indicate the scheduling request is to report an availability of retransmission traffic currently available for transmission. The UE 115 may transmit the scheduling request indicating the availability of retransmission traffic based on the configuration. The UE 115 may receive a grant for a portion of the retransmission traffic responsive to the scheduling request, and the UE 115 may transmit the portion of the retransmission traffic based on the grant. In some examples, the scheduling request may be transmitted based on one or more of a duration that the retransmission traffic has been waiting for retransmission, a quantity of unsuccessful transmissions associated with the retransmission traffic, or a quantity of unsuccessful HARQ feedbacks associated with the retransmission traffic. In some examples, the UE 115 may receive control signaling that indicates a buffer status report configuration. The buffer status report configuration may indicate that a buffer status report is to include one or more of a duration that the retransmission traffic has been waiting for retransmission, a HARQ identifier associated with the retransmission traffic, or a logical channel group associated with the retransmission traffic.

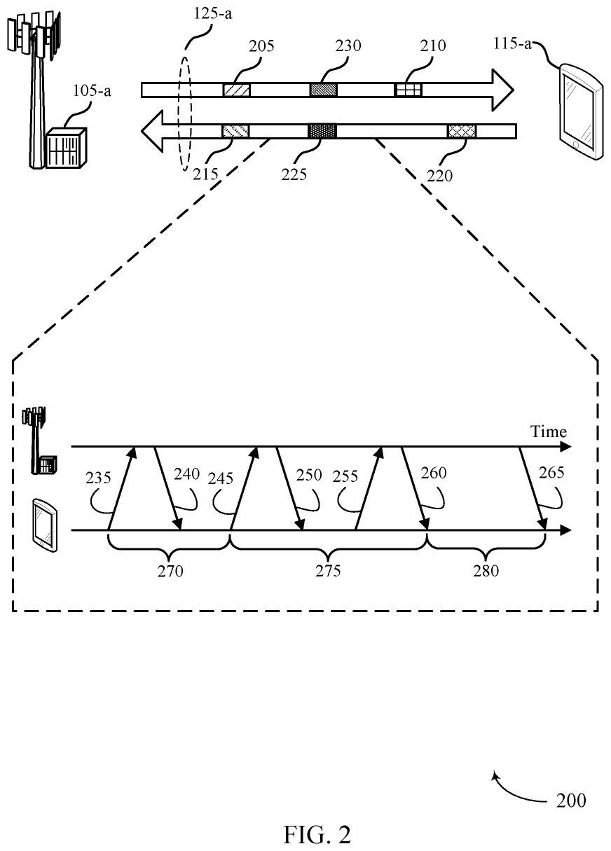

FIG. 2 shows an example of a wireless communications system 200 that supports techniques for RLC AM retransmissions in accordance with one or more aspects of the present disclosure. The wireless communications system 200 may implement aspects of or may be implemented by aspects of the wireless communications system 100. For example, the wireless communications system 200 includes a UE 115-a, which may be an example of a UE 115 as described herein. The wireless communications system 200 may also include a network entity 105-a, which may be an example of a network entity 105 as described herein.

The UE 115-a may communicate with the network entity 105-a using a communication link 125-a. The communication link 125-a may be an example of an NR or LTE link between the UE 115-a and the network entity 105-a. The communication link 125-a may include bi-directional links that enable both uplink and downlink communications. For example, the network entity 105-a may transmit downlink signals (e.g., downlink transmissions), such as downlink control signaling 205 and downlink data signals 210, to the UE 115-a using the communication link 125-a, and the UE 115-a may transmit uplink signals (e.g., uplink transmissions), such as uplink control signaling 215 and uplink data signals 220, to the network entity 105-a using the communication link 125-a.

In some examples, in the RLC AM mode, the UE 115-a may transmit one or more RLC PDUs 225 to the network entity, and the UE 115-a may store a copy of each of the transmitted RLC PDUs in a retransmission buffer. For each transmission of a RLC PDU, the UE 115-a may expect to receive an HARQ feedback message 230, such as an ACK or NACK feedback from the network entity 105-a. If the UE 115-a receives ACK feedback, the RLC PDU in the retransmission buffer may be discarded. If the UE 115-a receives NACK feedback or no response, the RLC PDU in the retransmission buffer may be retransmitted to the network entity 105-a.

In some extended reality (XR) applications, such as augmented reality applications, virtual reality applications, and mixed reality applications, the RLC retransmissions for operation of RLC AM may have a small packet delay budget. The total RLC AM latency may be attributed to several components, including an initial transmission delay and a per-retransmission delay. The UE 115-a may transmit a scheduling request (SR) 235 to the network entity 105-a, and the UE 115-a may receive a downlink control information (DCI) 240 with a grant allocating physical resources for an uplink data transmission (e.g., physical uplink shared channel (PUSCH)) associated with the SR 235. The duration of the SR 235 and DCI 240 may provide a transmission delay 270. The transmission delay 270 may comprise a round trip time (RTT) of the SR 235 and DCI 240 and possible buffer status report transmission and additional waiting for grants. In some examples, prior to the transmission delay 270 may be a queuing delay including a delay from a transmission of service data units (SDUs) ahead of the SR 235 and DCI 240 in a transmission queue.

In some cases, the UE 115-a may transmit a RLC PDU 245 to the network entity 105-a, and the UE 115-a may receive a HARQ-NACK 250. The UE 115-a may transmit a RLC PDU 255 to the network entity 105-a, and the UE 115-a may receive a new data indicator toggle (NDI) 260. The duration of the RLC PDU 245, the HARQ-NACK 250, the RLC PDU 255, and the NDI 260 may provide a transmission delay 275. The transmission delay 275 may be comprise a RTT of the RLC PDU 245, the HARQ-NACK 250, the RLC PDU 255, and the NDI 260. A per-retransmission delay 280 may comprise a duration from reception of the NDI 260 to a reception of a STATUS PDU 265. The per-retransmission delay 280 may include a time to start a reassembly timer that may be greater than one RTT for the receiver to detect a hole in the RLC sequence number (SN). The per-retransmission delay 280 may include a time of a reassembly timer for downlink and a duration for the STATUS PDU transmission. The duration for the STATUS PDU transmission may include a loss of the STATUS PDU and the UE 115-a and the network entity 105-a having to retransmit the STATUS PDU due to segmentation.

To reduce the total RLC AM latency, the per-retransmission delay 280 may be reduced by reducing the duration associated with the RLC retransmissions or HARQ retransmissions. In some examples, the RLC logic channel may be configured with an early retransmission feature where the RLC may be allowed to retransmit after a quantity of HARQ retransmission. For example, the UE 115-a may be configured to initiate RLC feedback after a configured quantity of HARQ retransmissions or after a timer. For example, the UE 115-a may receive control signaling 205 that indicates a retransmission configuration, and the retransmission configuration may indicate a threshold quantity. The UE 115-a may transmit the retransmission traffic based on a quantity of retransmissions associated with the retransmission traffic being greater than the threshold quantity of the retransmission configuration. In some cases, the RLC-config parameter may indicate a quantity of HARQ retransmissions at which the RLC transmitter may perform a retransmission. To determine the quantity of HARQ retransmissions, a retx_counter that counts the quantity of retransmissions may be incremented in the RLC transmitter. In some cases, due to an unavailability of HARQ feedback, the RLC transmitter may infer a loss with a STATUS NACK for SN or the quantity of HARQ retransmissions.

In some examples, the RLC may be configured with a timer to initiate an RLC retransmission. For example, the UE 115-a may receive control signaling 205 that indicates a retransmission configuration, and the retransmission configuration may indicate a threshold duration. The UE 115-a may transmit the retransmission traffic based at least in part on a duration associated with the retransmission delay being greater than the threshold duration of the retransmission configuration. In some cases, the RLC timer may be stopped when the UE 115-a receives a STATUS PDU with an ACK for the PDU or when HARQ feedback is received with the NDI toggled. In some examples, the UE 115-a may be configured to transmit the retransmission on a new carrier. For example, the UE 115-a may receive control signaling 205 that indicates a retransmission configuration, and the retransmission configuration may indicate that the retransmission is to be transmitted on a new carrier, and the UE 115-a transmits the retransmission on the new carrier. Transmitting the retransmission on the new carrier may solve the problem of outage of a carrier that may be affecting transmissions and retransmissions.

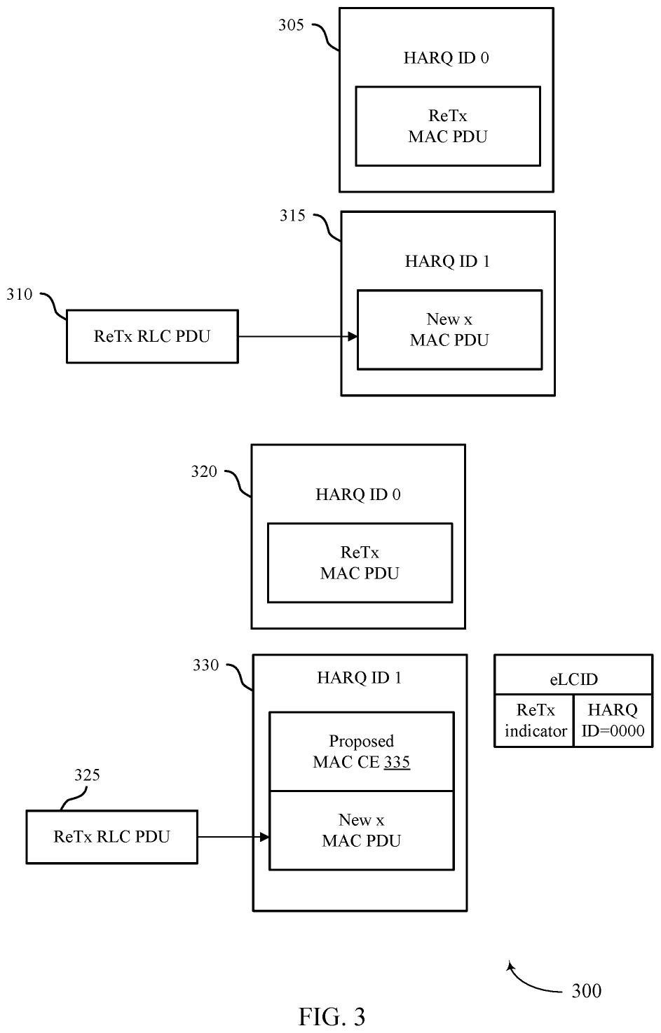

FIG. 3 shows examples of block diagrams 300 that supports techniques for RLC AM retransmissions in accordance with one or more aspects of the present disclosure. Aspects of the block diagrams 300 may implement, or be implemented by, aspects of wireless communications system 100 and the wireless communications system 200, or any combination thereof.

In some examples, the RLC logic channel may be configured with an early retransmission feature where the RLC may be allowed to retransmit after a quantity of one or more HARQ retransmissions. In some cases, the UE 115-a may automatically have two or more copies of the RLC PDU once a threshold quantity of HARQ retransmissions is reached. In some examples, the UE 115-a may indicate to the network entity 105-a that contents of the HARQ buffers are replicated. Initiating early RLC retransmission may be wasteful of resources for the carrier experiencing repeated HARQ failures. The network entity 105-a may consume resources to successfully transmit repeated content in the poor quality carrier. To avoid wasteful consumption of resources, the UE 115-a may inform the network entity 105-a of the redundancy of contents of the HARQ buffers through a good carrier.

Referring to FIG. 3, the UE 115-a may have a first copy of a RLC PDU 310 in a retransmission MAC PDU 305 with HARQ ID 0. When the threshold quantity of HARQ retransmissions is reached for the RLC PDU 310, the UE 115-a may prepare the retransmission RLC PDU 310 as a new transmission MAC PDU 320 with HARQ ID 1. The network entity 105-a may not be aware of the logic channel content in the HARQ buffer. The network entity 105-a may have an outdated buffer status report and may assume a grant associated with the retransmission RLC PDU 310 carries low latency traffic. The UE 115-a may have received low latency traffic between the buffer status report and grant transmissions. The network entity 105-a may consume resources to successfully deliver both redundant transmission content of the retransmission MAC PDU 305 and the new transmission MAC PDU 315. In this case, the network entity 105-a may be unaware that the RLC has prepared the same PDU as a new transmission aside from the HARQ retransmission. The redundant PDUs that the network entity is not aware of may waste HARQ retransmissions trying to deliver both of the MAC PDUs because transmission of both MAC PDUs may look like two new transmissions to the network entity 105-a.

In some examples, the possible redundancy from the RLC logic channel being configured with an early retransmission feature may be improved by including the HARQ process ID of an original transmission with the early retransmission. For example, the RLC retransmitted MAC PDU may contain a MAC CE or uplink control information (UCI) referring to the HARQ ID process that is being used for the initial transmission. Referring to FIG. 3, the UE 115-a may have a first copy of a RLC PDU 325 in a retransmission MAC PDU 320 with HARQ ID 0. When the threshold quantity of HARQ retransmissions is reached for the RLC PDU 325, the UE 115-a may prepare the retransmission RLC PDU 325 as a new transmission MAC PDU 330 with HARQ ID 1 that includes a MAC CE 335 referring to the HARQ ID 0 process of the initial transmission. In some cases, a UCI may be used to indicate the HARQ process ID of the initial transmission. If the UCI is used, the network entity 105-a may know about the redundancy pre-decoding any of the HARQ contents. In some cases, the network entity 105-a may infer that HARQ ID−0 and HARQ ID=1 maintain the same MAC PDU, and the network entity 105-a may clear the buffer of the MAC PDU 320 and the MAC PDU 330 via the NDI once one of the MAC PDU 320 and the MAC PDU 330 has been received. In some examples, the UE 115-a may clear both of the HARQ buffers associated with the MAC PDU 320 and the MAC PDU 330 when the NDI is toggle for one of the MAC PDU 320 and the MAC PDU 330.

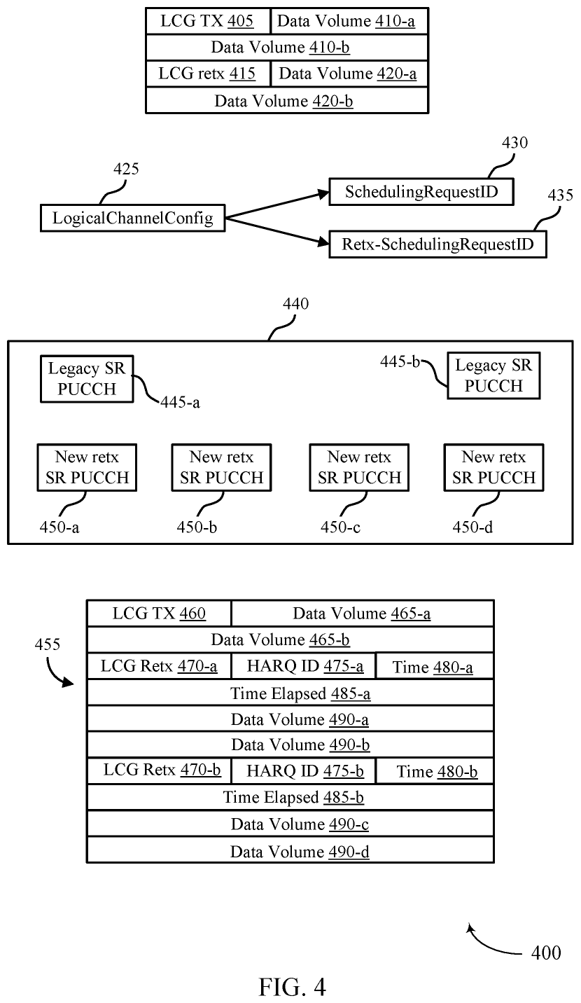

FIG. 4 shows examples of block diagrams 400 that support techniques for RLC AM retransmissions in accordance with one or more aspects of the present disclosure. Aspects of the block diagrams 400 may implement, or be implemented by, aspects of wireless communications system 100 and the wireless communications system 200, or any combination thereof.

In some examples, to reduce the total RLC AM latency, the scheduling request and buffer status report may be configured to differentiate reporting of new transmission traffic and retransmission traffic. A virtual logical channel where PDUs that satisfy some retransmission criteria may await fast retransmission. Since PDUs awaiting retransmission may have their own virtual logical channel, a scheduling request sequence for retransmissions may alert the network entity 105-a of pending or late retransmissions.

In some examples, to reduce the total RLC AM latency, the scheduling request and buffer status report may be configured to differentiate reporting of data volumes between transmission traffic or new traffic and retransmission traffic. For example, a logic channel group for the transmission traffic (LCG TX 405) may have a data volume 410-a and a data volume 410-b. A logic channel group for the retransmission traffic (LCG retx 415) may have a data volume 420-a and a data volume 420-b. By providing the data volumes associated with the new traffic and the retransmission traffic to the network entity 105-a, the network entity 105-a may have information and options between HARQ retransmission or parallelizing a new HARQ transmission. For example, the network entity 105-a may use the reported data volumes for the retransmission traffic to determine that the retransmission traffic is delayed and schedule additional resources to retransmit the retransmission traffic.

In some examples, the UE 115-a may be configured with two sets of scheduling requests associated with associate with physical uplink control channel (PUCCH) resources. A LogicalChannelConfig 425 may specify a SchedulingRequestID 430 and a RetxSchedulingRequestID 435. The SchedulingRequestID 430 may be a legacy scheduling request mapped to PUCCH resources. The RetxSchedulingRequestID 435 may be a new special retransmission scheduling request configured by the network entity 105-a. The RetxSchedulingRequestID 435 may be mapped to PUCCH resources. For example, the network entity 105-a may configure uplink resources 440 including legacy scheduling request PUCCH resources (e.g., legacy scheduling request PUCCH 445-a and legacy scheduling request PUCCH 445-b) and retransmission scheduling request PUCCH resources (e.g., new retransmission scheduling request PUCCH 450-a, new retransmission scheduling request PUCCH 450-b, new retransmission scheduling request PUCCH 450-c and new retransmission scheduling request PUCCH 450-d).

The network entity 105-a may know that PUCCH on the resources for the RetxSchedulingRequestID 435 may be more urgent, and the network entity 105-a may schedule the RetxSchedulingRequestID 435 without waiting for a buffer status report. In some examples, the criteria for using RetxSchedulingRequestID may be a function of the traffic latency. For example, the criteria for using RetxSchedulingRequestID may be a function of the latency observed in the layer two (L2) buffer, and PDUs that spend time more than a threshold duration in the buffer may trigger the retransmission scheduling request. In some cases, the criteria for using RetxSchedulingRequestID may be a function of the quantity of HARQ failures or attempted transmissions.

In some examples, the UE 115-a may receive control signaling 205 that indicates a configuration for a retransmission scheduling request, and the configuration may indicate that the retransmission scheduling request is to report an availability of retransmission traffic currently available for transmission. The UE 115-a may transmit retransmission scheduling request indicating the availability a quantity of retransmission traffic based on the configuration. The UE 115-a may receive, from the network entity 105-a, a grant for at least a portion of the retransmission traffic responsive to the retransmission scheduling request. The UE 115-a may transmit the portion of the retransmission traffic based on the first grant. In some cases, transmitting the retransmission scheduling request may be based on one or more of a duration that the retransmission traffic has been waiting for retransmission, a quantity of unsuccessful transmissions associated with the retransmission traffic, or a quantity of unsuccessful HARQ feedbacks associated with the retransmission traffic. In some examples, the retransmission scheduling request is associated with a logical channel identifier.

In some examples, a buffer status report may include separate information for transmissions and retransmissions. In some examples, the buffer status report may include a time elapsed between seeing the PDU at the packet data convergence protocol (PDCP) and transmitting the buffer status report with information regarding the PDU. The time elapsed between the PDU at the PDCP and transmitting the buffer status report may be the same information as the delay status report (DSR) in XR for the retransmission data volume. In some examples, the buffer status report may include a HARQ ID used to transmit the data of the PDU. The HARD ID may enable the network entity 105-a to assess whether to speed up the HARQ retransmission or initiate RLC parallel retransmission.

In some cases, if multiple HARQ buffers are going through retransmission, the UE 115-a may include each HARQ buffer in different fields of the buffer status report. The UE 115-a may not immediately report all data that moved to the HARQ buffer as retransmission traffic. In some examples, the UE 115-a may be configured with at least one criterion to include PDUs in the retransmission buffer for reporting in the buffer status report. For example, at least one criterion for classifying the PDU as retransmission traffic and reporting in the buffer status report may include a quantity of HARQ failures and a time elapse between receiving the RLC PDU in the buffer without a STATUS ACK or alternatively a HARQ NDI toggle.

Referring to FIG. 4, a buffer status report 455 may include a logic channel group for the transmission traffic (LCG TX 460), and the LCG TX 460 may have a data volume 465-a and a data volume 465-b. The buffer status report 455 may include a logic channel group for the retransmission traffic (LCG retx 470-a), and the LCG retx 470-a may have a data volume 490-a and a data volume 490-b. For the retransmission traffic, the buffer status report 455 may include a HARQ ID 475-a used to transmit the data of the PDU and a time 480-a of the original transmission. For the retransmission traffic, the buffer status report 455 may include a time elapsed 485-a indicating a duration between seeing the PDU at the PDCP and transmitting the buffer status report. In some cases, the buffer status report 455 may include information from another HARQ buffer going through retransmission by including a LCG retx 470-b and associated data volume 490-c and data volume 490-d of the additional HARQ buffer. The buffer status report 455 may include a HARQ ID 475-b, a time 480-b, and a time elapsed 485-b associated with the retransmission traffic of the additional HARQ buffer.

In some examples, the UE 115-a may receive control signaling 205 that indicates a configuration for a buffer status report, and the configuration may indicate the buffer status report is to include one or more of a duration that the retransmission traffic has been waiting for retransmission, a HARQ identifier associated with the retransmission traffic, or a logical channel group associated with the retransmission traffic. The UE 115-a may transmit the buffer status report based on the configuration. The UE 115-a may receive, from the network entity 105-a, a grant for at least a portion of the retransmission traffic responsive to the buffer status report. The UE 115-a may transmit the portion of the retransmission traffic based on the grant.

In some examples, the UE 115-a may receive control signaling 205 that indicates a configuration for a buffer status report, and the configuration may indicate that buffer status report is to report the quantity of retransmission traffic associated with a first logical channel group and a quantity of new traffic associated with a second logical channel group. The UE 115-a may transmit the buffer status report based on the configuration. The UE 115-a may receive, from the network entity 105-a, a grant for at least a portion of the retransmission traffic, a portion of the new traffic, or both based on the buffer status report. The UE 115-a may transmit the portion of the retransmission traffic, the portion of the new traffic or both based on the grant.

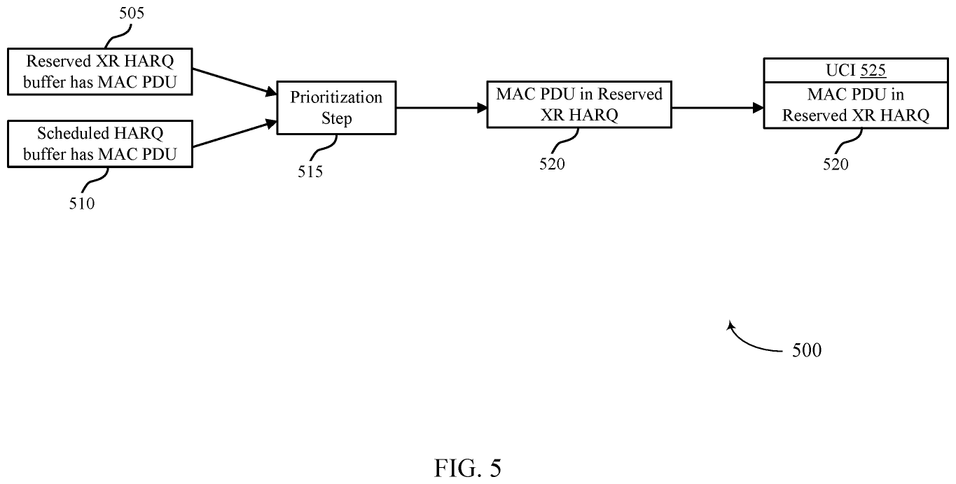

FIG. 5 shows an example of a block diagram 500 that supports techniques for RLC AM retransmissions in accordance with one or more aspects of the present disclosure. Aspects of the block diagram 500 may implement, or be implemented by, aspects of wireless communications system 100 and the wireless communications system 200, or any combination thereof.

In some examples, the network entity 105-a may reserve one or more HARQ IDs with high priority for low latency traffic. The reserved HARQ IDs may allow the network entity 105-a to configure a fast lane for low latency retransmissions. From a MAC point of view, a RLC retransmission may look like a new HARQ transmission, so the RLC retransmission may not be prioritized at the MAC using an inter-UE prioritization framework. Currently, the MAC specification does not allow prioritizing a new MAC transmission over HARQ retransmissions. By defining the reserved HARQ IDs, inter-UE prioritization may be applied.

In some examples, the reserved HARQ IDs may be configured with a high physical layer priority to allow the reserved HARQ IDs to benefit from inter-UE prioritization with other MAC PDUs and to be transmitted with a higher priority. In some cases, the reserved HARQ IDs may be configured with a retransmission timer. The retransmission timer may be a configured grant retransmission timer (CGRT) for the reserved HARQ ID for low latency traffic. The UE 115-a may wait for the retransmission timer and then autonomously retransmit the MAC PDU associated with the reserved HARQ ID if no HARQ feedback is received. The reserved HARQ IDs may be used for the new transmissions or retransmissions of low latency RLC XR traffic.

In some cases, the reserved HARQ IDs may win an inter-UE prioritization which may not be known to the network entity 105-a. For example, the network entity 105-a may configure a configured grant with a HARQ ID (e.g., HARQ ID=6), and the network entity 105-a may not know that the UE 115-a has prioritized an XR reserved HARQ ID (e.g., HARQ ID=0). To inform the network entity 105-a that the UE 115-a is using the reserved HARQ ID instead of the scheduled HARQ ID, the UE 115-a may include a UCI with the MAC PDU. In some cases, to inform the network entity 105-athat the UE 115-a is using the reserved HARQ ID instead of the scheduled HARQ ID, the UE 115-a may include a MAC CE with the MAC PDU. Referring to FIG. 5, the UE 115-a may have a reserved XR HARQ buffer with MAC PDU 505 and a scheduled HARQ buffer with MAC PDU 510. The UE 115-a may perform a prioritization step 515 that inter-UE prioritizes a MAC PDU in reserved XR HARQ 520. To inform the network entity 105-a that the UE 115-a is using the reserved HARQ ID, a UCI 525 is included with the MAC PDU in reserved XR HARQ 520 to for a resulting transport block.

In some examples, the network entity 105-a may configure the UE 115-a with criteria to use the low latency reserved HARQ IDs. For example, the network entity 105-a may configure a logic channel (LCH) reservation similar to a configured grant for the UE 115-a. In some examples, the network entity 105-a may configure a LCH reservation and some retransmission criteria such as time elapsed in the RLC buffer for the PDU or quantity of HARQ failures. The network entity 105-a may reserve some HARQ IDs that may use some extra capabilities to ensure low latency delivery with prioritization or retransmission timer to avoid continuous redundant transmissions and provide fast RLC retransmissions. In some cases, the UE 115-a may receive control signaling that indicates a HARQ ID associated with high priority transmission or retransmission traffic, and the UE 115-a may transmit a portion of the retransmission traffic or a portion of the new transmission based on the HARQ ID being associated with the portion of the retransmission traffic or the portion of the new transmission.

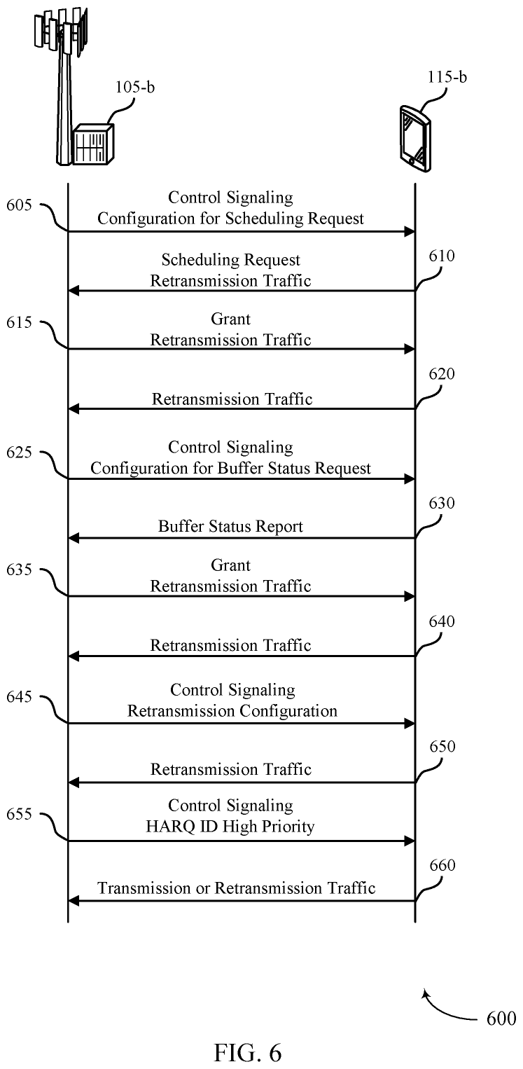

FIG. 6 shows an example of a process flow 600 that supports techniques for RLC AM retransmissions in accordance with one or more aspects of the present disclosure. In some examples, the process flow 600 may implement or be implemented by aspects of the wireless communications systems 100 and 200 as described with reference to FIGS. 1 and 2, respectively. For example, the process flow 600 may be implemented by a network entity 105-b, which may be an example of the network entities 105 as described with reference to FIGS. 1 and 2. The process flow 600 may be implemented by a UE 115-b, which may be an example of the UEs as described with reference to FIGS. 1 and 2.

In some examples, the operations illustrated in process flow 600 may be performed by hardware (e.g., including circuitry, processing blocks, logic components, and other components), code (e.g., software executes d by a processor), or any combination thereof. Alternative examples of the following may be implemented, where some steps are performed in a different order than described or are not performed at all. In some cases, steps may include additional features not mentioned below, or further steps may be added.

At 605, the UE 115-b may receiving first control signaling that indicates a first configuration for a first scheduling request, and the first configuration may indicate the first scheduling request is to report an availability of retransmission traffic currently available for transmission. In some examples, the UE 115-b may receive second control signaling that indicates a second configuration for a second scheduling request, and the second configuration indicating the second scheduling request is to report that new traffic is available for transmission.

At 610, the UE 115-b may transmit the first scheduling request that retransmission traffic is available for transmission based on the first configuration. In some examples, the transmitting the first scheduling request may be based at least in part on one or more of a duration that the retransmission traffic has been waiting for retransmission, a quantity of unsuccessful transmissions associated with the retransmission traffic, or a quantity of unsuccessful hybrid automatic repeat feedbacks associated with the retransmission traffic. In some examples, the first scheduling request is associated with first logical channel identifier. In some examples, the UE 115-b may transmit the second scheduling request indicating the quantity of new traffic based on the second configuration. In some examples, the second scheduling request may be associated with a second logical channel identifier. In some examples, the retransmission traffic may be associated with a quantity of unsuccessful transmissions or a delay duration without an acknowledgment feedback or an new data indicator toggle.

At 615, the UE 115-b may receive a first grant for at least a first portion of the retransmission traffic responsive to the first scheduling request. In some examples, the UE 115-b may receive a second grant for at least a portion of the new traffic responsive to the second scheduling request.

At 620, the UE 115-b may transmit the first portion of the retransmission traffic based at least in part on the first grant. In some examples, the UE 115-b may transmit the portion of the new traffic based at least in part on the second grant.

At 625, the UE 115-b may receive third control signaling that indicates a third configuration associated with a buffer status report, the third configuration indicating the buffer status report is to comprise a duration that the retransmission traffic has been waiting for retransmission, a hybrid automatic repeat identifier associated with the retransmission traffic, a logical channel group associated with the retransmission traffic. In some examples, the third configuration may indicate the buffer status report is to report a quantity of retransmission traffic that is available, such as a quantity of retransmission traffic associated with a first logical channel group and a quantity of new traffic associated with the first logical channel group or a second logical channel group.

At 630, the UE 115-b may transmit the buffer status report, subsequent to transmitting the retransmission traffic, based on the third configuration.

At 635, the UE 115-b may receive a third grant for at least a second portion of the retransmission traffic responsive to the buffer status report. In some examples, the third grant may be for one or more of a second portion of the retransmission traffic, or a portion of the new traffic based on the buffer status report

At 640, the UE 115-b may transmit the second portion of the retransmission traffic based at least in part on the third grant. In some examples, the UE 115-b may transmit the second portion of the retransmission traffic, the portion of the new traffic, or both based at least in part on the third grant.

At 645, the UE 115-b may receive control signaling that indicates a retransmission configuration, and the retransmission configuration may indicate a threshold quantity.

At 650, the UE 115-b may transmit at least a portion of the retransmission traffic based on a quantity of retransmissions associated with the retransmission traffic being greater than the threshold quantity of the retransmission configuration. In some examples, the retransmission traffic may include a HARQ process identification of an original transmission associated with retransmission traffic.

At 655, the UE 115-b may receive control signaling that indicates a HARQ identifier associated with high priority transmission or retransmission traffic.

At 660, the UE 115-b may transmit at least a portion of the retransmission traffic based on the HARQ identifier being associated with the portion of the retransmission traffic.

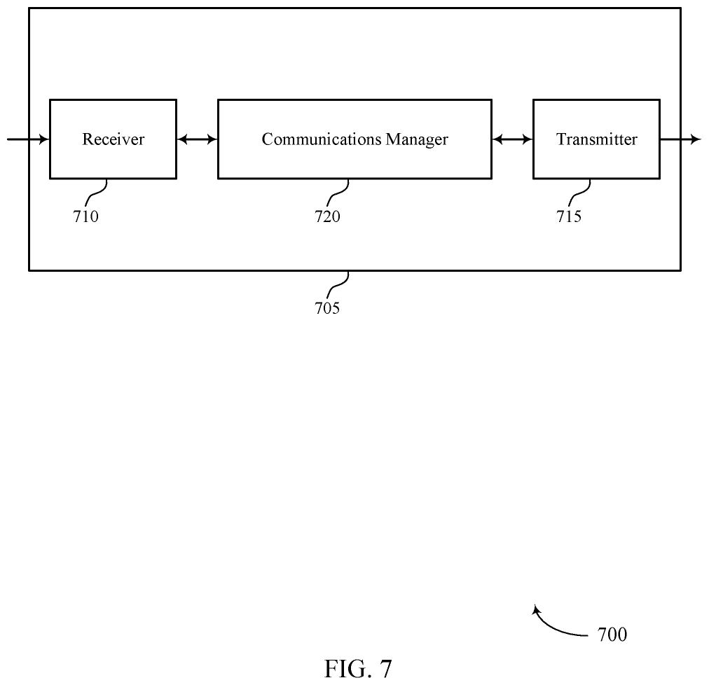

FIG. 7 shows a block diagram 700 of a device 705 that supports techniques for RLC AM retransmissions in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for RLC AM retransmissions). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for RLC AM retransmissions). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of techniques for RLC AM retransmissions as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. For example, the communications manager 720 is capable of, configured to, or operable to support a means for receiving first control signaling that indicates a first configuration for a first scheduling request, the first configuration indicating the first scheduling request is to report an availability of retransmission traffic currently available for transmission. The communications manager 720 is capable of, configured to, or operable to support a means for transmitting the first scheduling request indicating the availability of retransmission traffic based on the first configuration. The communications manager 720 is capable of, configured to, or operable to support a means for receiving a first grant for at least a first portion of the retransmission traffic responsive to the first scheduling request. The communications manager 720 is capable of, configured to, or operable to support a means for transmitting the first portion of the retransmission traffic based on the first grant.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources.

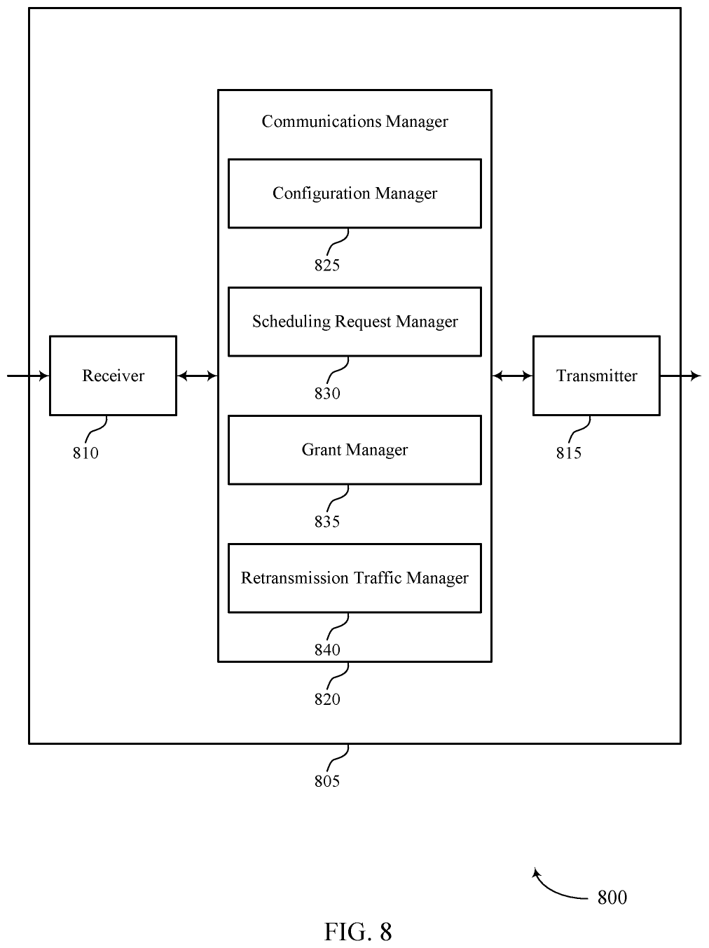

FIG. 8 shows a block diagram 800 of a device 805 that supports techniques for RLC AM retransmissions in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for RLC AM retransmissions). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for RLC AM retransmissions). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for RLC AM retransmissions as described herein. For example, the communications manager 820 may include a configuration manager 825, a scheduling request manager 830, a grant manager 835, a retransmission traffic manager 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. The configuration manager 825 is capable of, configured to, or operable to support a means for receiving first control signaling that indicates a first configuration for a first scheduling request, the first configuration indicating the first scheduling request is to report an availability of retransmission traffic currently available for transmission. The scheduling request manager 830 is capable of, configured to, or operable to support a means for transmitting the first scheduling request indicating the availability of retransmission traffic based on the first configuration. The grant manager 835 is capable of, configured to, or operable to support a means for receiving a first grant for at least a first portion of the retransmission traffic responsive to the first scheduling request. The retransmission traffic manager 840 is capable of, configured to, or operable to support a means for transmitting the first portion of the retransmission traffic based on the first grant.

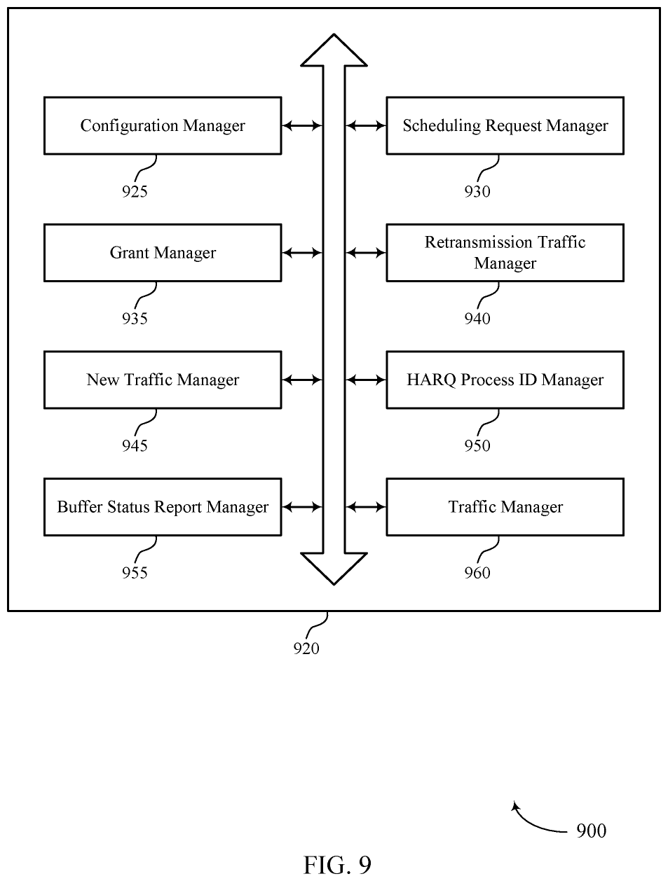

FIG. 9 shows a block diagram 900 of a communications manager 920 that supports techniques for RLC AM retransmissions in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for RLC AM retransmissions as described herein. For example, the communications manager 920 may include a configuration manager 925, a scheduling request manager 930, a grant manager 935, a retransmission traffic manager 940, a new traffic manager 945, an HARQ process ID manager 950, a buffer status report manager 955, a traffic manager 960, or any combination thereof. Each of these components, or components or subcomponents thereof (e.g., one or more processors, one or more memories), may communicate, directly or indirectly, with one another (e.g., via one or more buses).

The communications manager 920 may support wireless communication in accordance with examples as disclosed herein. The configuration manager 925 is capable of, configured to, or operable to support a means for receiving first control signaling that indicates a first configuration for a first scheduling request, the first configuration indicating the first scheduling request is to report an availability of retransmission traffic currently available for transmission. The scheduling request manager 930 is capable of, configured to, or operable to support a means for transmitting the first scheduling request indicating the availability of retransmission traffic based on the first configuration. The grant manager 935 is capable of, configured to, or operable to support a means for receiving a first grant for at least a first portion of the retransmission traffic responsive to the first scheduling request. The retransmission traffic manager 940 is capable of, configured to, or operable to support a means for transmitting the first portion of the retransmission traffic based on the first grant.

In some examples, transmitting the first scheduling request is based on one or more of a duration that the retransmission traffic has been waiting for retransmission, a quantity of unsuccessful transmissions associated with the retransmission traffic, or a quantity of unsuccessful hybrid automatic repeat feedbacks associated with the retransmission traffic.

In some examples, the first scheduling request is associated with a first logical channel identifier.

In some examples, the configuration manager 925 is capable of, configured to, or operable to support a means for receiving second control signaling that indicates a second configuration for a second scheduling request, the second configuration indicating the second scheduling request is to report a quantity of new traffic available for transmission. In some examples, the scheduling request manager 930 is capable of, configured to, or operable to support a means for transmitting the second scheduling request indicating the quantity of new traffic based on the second configuration. In some examples, the grant manager 935 is capable of, configured to, or operable to support a means for receiving a second grant for at least a portion of the new traffic responsive to the second scheduling request. In some examples, the new traffic manager 945 is capable of, configured to, or operable to support a means for transmitting the portion of the new traffic based on the second grant.

In some examples, the second scheduling request is associated with a second logical channel identifier.

In some examples, the configuration manager 925 is capable of, configured to, or operable to support a means for receiving third control signaling that indicates a third configuration associated with a buffer status report, the third configuration indicating the buffer status report is to include one or more of a duration that the retransmission traffic has been waiting for retransmission, a hybrid automatic repeat identifier associated with the retransmission traffic, or a logical channel group associated with the retransmission traffic.

In some examples, the buffer status report manager 955 is capable of, configured to, or operable to support a means for transmitting the buffer status report, subsequent to transmitting the retransmission traffic based on the first grant, based on the third configuration. In some examples, the grant manager 935 is capable of, configured to, or operable to support a means for receiving a third grant for at least a second portion of the retransmission traffic responsive to the buffer status report. In some examples, the retransmission traffic manager 940 is capable of, configured to, or operable to support a means for transmitting the second portion of the retransmission traffic based on the third grant.

In some examples, the configuration manager 925 is capable of, configured to, or operable to support a means for receiving third control signaling that indicates a third configuration associated with a buffer status report, the third configuration indicating the buffer status report is to report the quantity of retransmission traffic associated with a first logical channel group and a quantity of new traffic associated with a second logical channel group.

In some examples, the buffer status report manager 955 is capable of, configured to, or operable to support a means for transmitting the buffer status report, based on the third configuration. In some examples, the grant manager 935 is capable of, configured to, or operable to support a means for receiving a third grant for at least a second portion of the retransmission traffic, a portion of the new traffic, or both based on the buffer status report. In some examples, the traffic manager 960 is capable of, configured to, or operable to support a means for transmitting the second portion of the retransmission traffic, the portion of the new traffic, or both based on the third grant.

In some examples, the retransmission traffic is associated with a quantity of unsuccessful transmissions or a delay duration without an acknowledgment feedback or an new data indicator toggle.

In some examples, the configuration manager 925 is capable of, configured to, or operable to support a means for receiving third control signaling that indicates a retransmission configuration, the retransmission configuration indicating a threshold quantity. In some examples, the retransmission traffic manager 940 is capable of, configured to, or operable to support a means for transmitting at least a portion of the retransmission traffic based on a quantity of retransmissions associated with the retransmission traffic being greater than the threshold quantity of the retransmission configuration.

In some examples, the retransmission traffic includes a hybrid automatic repeat process identification of an original transmission associated with retransmission traffic.

In some examples, the HARQ process ID manager 950 is capable of, configured to, or operable to support a means for receiving third control signaling that indicates a hybrid automatic repeat process identifier associated with high priority transmission or retransmission traffic. In some examples, the retransmission traffic manager 940 is capable of, configured to, or operable to support a means for transmitting at least a portion of the retransmission traffic based on the hybrid automatic repeat process identifier being associated with the portion of the retransmission traffic.

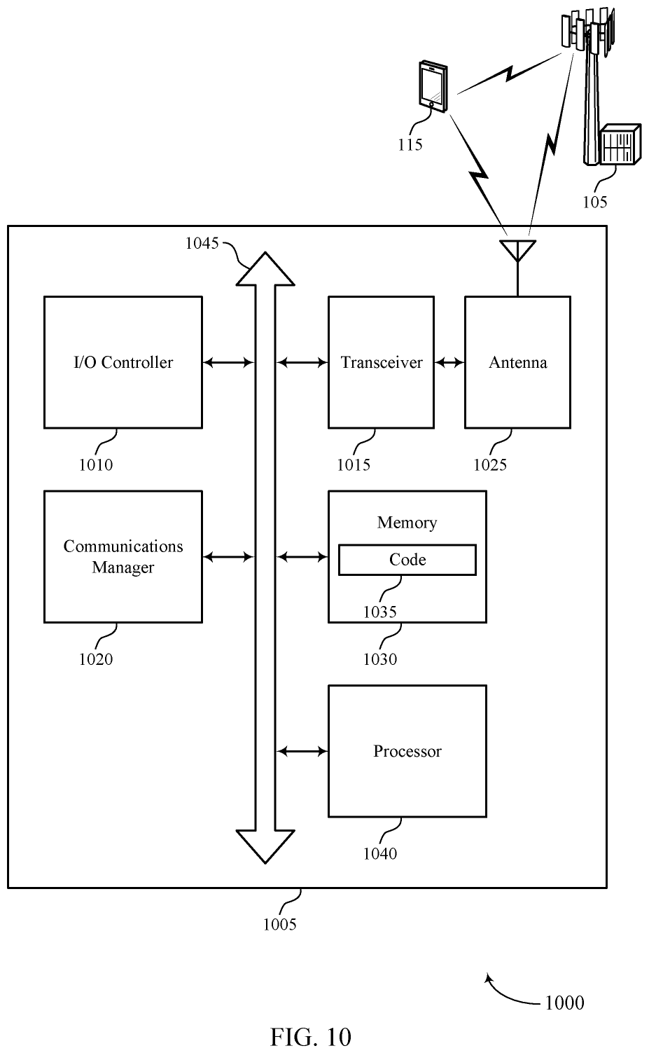

FIG. 10 shows a diagram of a system 1000 including a device 1005 that supports techniques for RLC AM retransmissions in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent

hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting techniques for RLC AM retransmissions). For example, the device 1005 or a component of the device 1005 may include at least one processor 1040 and at least one memory 1030 coupled with or to the at least one processor 1040, the at least one processor 1040 and the at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communication in accordance with examples as disclosed herein. For example, the communications manager 1020 is capable of, configured to, or operable to support a means for receiving first control signaling that indicates a first configuration for a first scheduling request, the first configuration indicating the first scheduling request is to report an availability of retransmission traffic currently available for transmission. The communications manager 1020 is capable of, configured to, or operable to support a means for transmitting the first scheduling request indicating the availability of retransmission traffic based on the first configuration. The communications manager 1020 is capable of, configured to, or operable to support a means for receiving a first grant for at least a first portion of the retransmission traffic responsive to the first scheduling request. The communications manager 1020 is capable of, configured to, or operable to support a means for transmitting the first portion of the retransmission traffic based on the first grant.

By including or configuring the communications manager 1020 in accordance with examples as described herein, the device 1005 may support techniques for reduced latency, more efficient utilization of communication resources, improved coordination between devices, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of techniques for RLC AM retransmissions as described herein, or the at least one processor 1040 and the at least one memory 1030 may be otherwise configured to, individually or collectively, perform or support such operations.

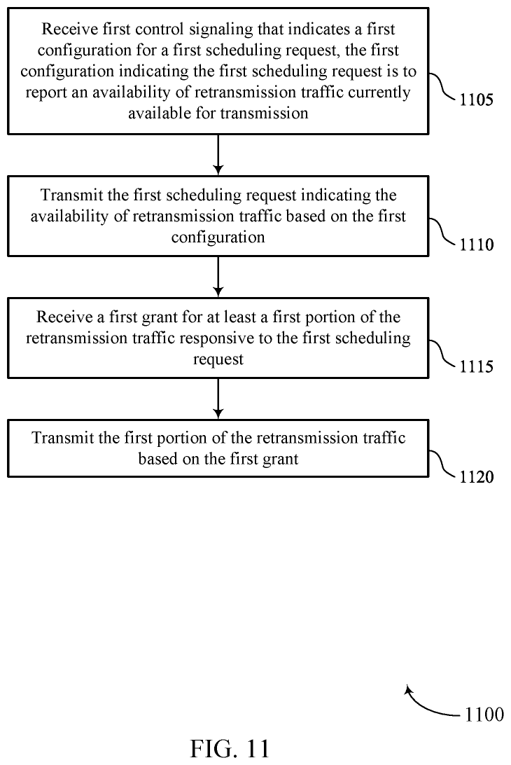

FIG. 11 shows a flowchart illustrating a method 1100 that supports techniques for RLC AM retransmissions in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving first control signaling that indicates a first configuration for a first scheduling request, the first configuration indicating the first scheduling request is to report an availability of retransmission traffic currently available for transmission. The operations of 1105 may be performed in accordance with examples as disclosed herein. In some examples, aspects of the operations of 1105 may be performed by a configuration manager 925 as described with reference to FIG. 9.

At 1110, the method may include transmitting the first scheduling request indicating the availability of retransmission traffic based on the first configuration. The operations of 1110 may be performed in accordance with examples as disclosed herein. In some examples, aspects of the operations of 1110 may be performed by a scheduling request manager 930 as described with reference to FIG. 9.

At 1115, the method may include receiving a first grant for at least a first portion of the retransmission traffic responsive to the first scheduling request. The operations of 1115 may be performed in accordance with examples as disclosed herein. In some examples, aspects of the operations of 1115 may be performed by a grant manager 935 as described with reference to FIG. 9.

At 1120, the method may include transmitting the first portion of the retransmission traffic based on the first grant. The operations of 1120 may be performed in accordance with examples as disclosed herein. In some examples, aspects of the operations of 1120 may be performed by a retransmission traffic manager 940 as described with reference to FIG. 9.

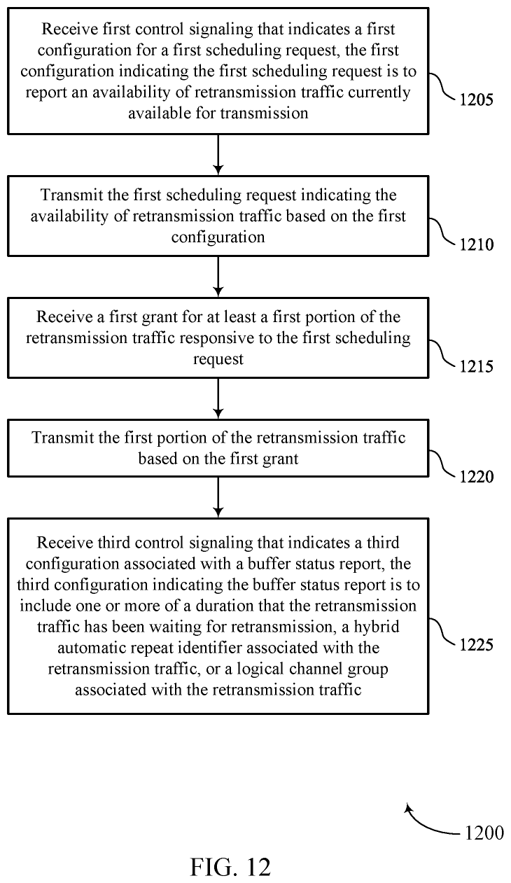

FIG. 12 shows a flowchart illustrating a method 1200 that supports techniques for RLC AM retransmissions in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include receiving first control signaling that indicates a first configuration for a first scheduling request, the first configuration indicating the first scheduling request is to report an availability of retransmission traffic currently available for transmission. The operations of 1205 may be performed in accordance with examples as disclosed herein. In some examples, aspects of the operations of 1205 may be performed by a configuration manager 925 as described with reference to FIG. 9.

At 1210, the method may include transmitting the first scheduling request indicating the availability of retransmission traffic based on the first configuration. The operations of 1210 may be performed in accordance with examples as disclosed herein. In some examples, aspects of the operations of 1210 may be performed by a scheduling request manager 930 as described with reference to FIG. 9.

At 1215, the method may include receiving a first grant for at least a first portion of the retransmission traffic responsive to the first scheduling request. The operations of 1215 may be performed in accordance with examples as disclosed herein. In some examples, aspects of the operations of 1215 may be performed by a grant manager 935 as described with reference to FIG. 9.

At 1220, the method may include transmitting the first portion of the retransmission traffic based on the first grant. The operations of 1220 may be performed in accordance with examples as disclosed herein. In some examples, aspects of the operations of 1220 may be performed by a retransmission traffic manager 940 as described with reference to FIG. 9.

At 1225, the method may include receiving third control signaling that indicates a third configuration associated with a buffer status report, the third configuration indicating the buffer status report is to include one or more of a duration that the retransmission traffic has been waiting for retransmission, a hybrid automatic repeat identifier associated with the retransmission traffic, or a logical channel group associated with the retransmission traffic. The operations of 1225 may be performed in accordance with examples as disclosed herein. In some examples, aspects of the operations of 1225 may be performed by a configuration manager 925 as described with reference to FIG. 9.

The following aspects are given by way of illustration. Examples of the following aspects may be combined with examples or embodiments shown or discussed in relation to the figures or elsewhere herein.

Aspect 1 is a method for wireless communication by a UE that includes: receiving first control signaling that indicates a first configuration for a first scheduling request, the first configuration indicating the first scheduling request is to report an availability of retransmission traffic currently available for transmission; transmitting the first scheduling request indicating the availability of retransmission traffic based at least in part on the first configuration; receiving a first grant for at least a first portion of the retransmission traffic responsive to the first scheduling request; and transmitting the first portion of the retransmission traffic based at least in part on the first grant.

In Aspect 2, the method of aspect 1 that includes transmitting the first scheduling request based at least in part on one or more of a duration that the retransmission traffic has been waiting for retransmission, a quantity of unsuccessful transmissions associated with the retransmission traffic, or a quantity of unsuccessful hybrid automatic repeat feedbacks associated with the retransmission traffic.

In Aspect 3, the method of any of aspects 1-2 that includes the first scheduling request being associated with a first logical channel identifier.

In Aspect 4, the method of any of aspects 1-3 further includes: receiving second control signaling that indicates a second configuration for a second scheduling request, the second configuration indicating the second scheduling request is to report a quantity of new traffic available for transmission; transmitting the second scheduling request indicating the quantity of new traffic based at least in part on the second configuration; receiving a second grant for at least a portion of the new traffic responsive to the second scheduling request; and transmitting the portion of the new traffic based at least in part on the second grant.

In Aspect 5, the method of aspect 4 that includes the second scheduling request being associated with a second logical channel identifier.

In Aspect 6, the method of any of aspects 1-5 further includes: receiving third control signaling that indicates a third configuration associated with a buffer status report, the third configuration indicating the buffer status report is to comprise one or more of a duration that the retransmission traffic has been waiting for retransmission, a hybrid automatic repeat identifier associated with the retransmission traffic, or a logical channel group associated with the retransmission traffic.

In Aspect 7, the method of aspect 6 further includes: transmitting the buffer status report, subsequent to transmitting the retransmission traffic based at least in part on the first grant, based at least in part on the third configuration; receiving a third grant for at least a second portion of the retransmission traffic responsive to the buffer status report; and transmitting the second portion of the retransmission traffic based at least in part on the third grant.

In Aspect 8, the method of any of aspects 1-5 further includes: receiving third control signaling that indicates a third configuration associated with a buffer status report, the third configuration indicating the buffer status report is to report the quantity of retransmission traffic associated with a first logical channel group and a quantity of new traffic associated with a second logical channel group.

In Aspect 9, the method of aspect 8 further includes: transmitting the buffer status report, based at least in part on the third configuration; receiving a third grant for at least a second portion of the retransmission traffic, a portion of the new traffic, or both based at least in part on the buffer status report; and transmitting the second portion of the retransmission traffic, the portion of the new traffic, or both based at least in part on the third grant.

In Aspect 10, the method of any of aspects 1-9 that includes the retransmission traffic being associated with a quantity of unsuccessful transmissions or a delay duration without an acknowledgment feedback or an new data indicator toggle.

In Aspect 11, the method of any of aspects 1-10 further includes: receiving control signaling that indicates a retransmission configuration, the retransmission configuration indicating a threshold quantity; and transmitting at least a portion of the retransmission traffic based at least in part on a quantity of retransmissions associated with the retransmission traffic being greater than the threshold quantity of the retransmission configuration.

In Aspect 12, the method of any of aspects 1-11 that includes the retransmission traffic comprises a hybrid automatic repeat process identification of an original transmission associated with retransmission traffic.

In Aspect 13, the method of any of aspects 1-12 further includes: receiving third control signaling that indicates a hybrid automatic repeat process identifier associated with high priority transmission or retransmission traffic; and transmitting at least a portion of the retransmission traffic based at least in part on the hybrid automatic repeat process identifier being associated with the portion of the retransmission traffic.

Aspect 14 is a UE for wireless communication including one or more memories storing processor-executable code, and one or more processors coupled with the one or more memories and individually or collectively operable to execute the code to cause the UE to implement a method of any of aspects 1-13.

Aspect 15 is a UE for wireless communication including means for implementing a method or realizing an apparatus as in any of aspects 1-13.

Aspect 16 is a non-transitory computer-readable medium storing code for wireless communication, the code comprising instructions executable by one or more processors to implement a method of any of aspects 1-13.

Examples of these aspects may be combined with aspects or embodiments disclosed in other implementations.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control signaling that indicates a first configuration for a first scheduling request, the first configuration indicating the first scheduling request is to report an availability of retransmission traffic currently available for transmission;
transmit the first scheduling request indicating the availability of retransmission traffic based at least in part on the first configuration;
receive a first grant for at least a first portion of the retransmission traffic responsive to the first scheduling request; and
transmit the first portion of the retransmission traffic based at least in part on the first grant.

2. The UE of claim 1, wherein transmitting the first scheduling request is based at least in part on one or more of a duration that the retransmission traffic has been waiting for retransmission, a quantity of unsuccessful transmissions associated with the retransmission traffic, or a quantity of unsuccessful hybrid automatic repeat feedbacks associated with the retransmission traffic.

3. The UE of claim 1, wherein the first scheduling request is associated with a first logical channel identifier.

4. The UE of claim 1, wherein the one or more processors are individually or collectively further operable to execute the code to cause the UE to:
receive second control signaling that indicates a second configuration for a second scheduling request, the second configuration indicating the second scheduling request is to report a quantity of new traffic available for transmission;
transmit the second scheduling request indicating the quantity of new traffic based at least in part on the second configuration;
receive a second grant for at least a portion of the new traffic responsive to the second scheduling request; and
transmit the portion of the new traffic based at least in part on the second grant.

5. The UE of claim 4, wherein the second scheduling request is associated with a second logical channel identifier.

6. The UE of claim 1, wherein the one or more processors are individually or collectively further operable to execute the code to cause the UE to:
receive third control signaling that indicates a third configuration associated with a buffer status report, the third configuration indicating the buffer status report is to comprise one or more of a duration that the retransmission traffic has been waiting for retransmission, a hybrid automatic repeat identifier associated with the retransmission traffic, or a logical channel group associated with the retransmission traffic.

7. The UE of claim 6, wherein the one or more processors are individually or collectively further operable to execute the code to cause the UE to:
transmit the buffer status report, subsequent to transmitting the retransmission traffic based at least in part on the first grant, based at least in part on the third configuration;
receive a third grant for at least a second portion of the retransmission traffic responsive to the buffer status report; and
transmit the second portion of the retransmission traffic based at least in part on the third grant.

8. The UE of claim 1, wherein the one or more processors are individually or collectively further operable to execute the code to cause the UE to:
receive third control signaling that indicates a third configuration associated with a buffer status report, the third configuration indicating the buffer status report is to report a quantity of retransmission traffic associated with a first logical channel group and a quantity of new traffic associated with a second logical channel group.

9. The UE of claim 8, wherein the one or more processors are individually or collectively further operable to execute the code to cause the UE to:
transmit the buffer status report, based at least in part on the third configuration;
receive a third grant for at least a second portion of the retransmission traffic, a portion of the new traffic, or both based at least in part on the buffer status report; and
transmit the second portion of the retransmission traffic, the portion of the new traffic, or both based at least in part on the third grant.

10. The UE of claim 1, wherein the retransmission traffic is associated with a quantity of unsuccessful transmissions or a delay duration without an acknowledgment feedback or an new data indicator toggle.

11. The UE of claim 1, wherein the one or more processors are individually or collectively further operable to execute the code to cause the UE to:
receive third control signaling that indicates a retransmission configuration, the retransmission configuration indicating a threshold quantity; and
transmit at least a portion of the retransmission traffic based at least in part on a quantity of retransmissions associated with the retransmission traffic being greater than the threshold quantity of the retransmission configuration.

12. The UE of claim 1, wherein the retransmission traffic comprises a hybrid automatic repeat process identification of an original transmission associated with retransmission traffic.

13. The UE of claim 1, wherein the one or more processors are individually or collectively further operable to execute the code to cause the UE to:
receive third control signaling that indicates a hybrid automatic repeat process identifier associated with high priority transmission or retransmission traffic; and
transmit at least a portion of the retransmission traffic based at least in part on the hybrid automatic repeat process identifier being associated with the portion of the retransmission traffic.

14. A method for wireless communication by a user equipment (UE), comprising:
receiving first control signaling that indicates a first configuration for a first scheduling request, the first configuration indicating the first scheduling request is to report an availability of retransmission traffic currently available for transmission;
transmitting the first scheduling request indicating the availability of retransmission traffic based at least in part on the first configuration;
receiving a first grant for at least a first portion of the retransmission traffic responsive to the first scheduling request; and
transmitting the first portion of the retransmission traffic based at least in part on the first grant.

15. The method of claim 14, wherein transmitting the first scheduling request is based at least in part on one or more of a duration that the retransmission traffic has been waiting for retransmission, a quantity of unsuccessful transmissions associated with the retransmission traffic, or a quantity of unsuccessful hybrid automatic repeat feedbacks associated with the retransmission traffic.

16. The method of claim 14, further comprising:
receiving third control signaling that indicates a third configuration associated with a buffer status report, the third configuration indicating the buffer status report is to comprise one or more of a duration that the retransmission traffic has been waiting for retransmission, a hybrid automatic repeat identifier associated with the retransmission traffic, or a logical channel group associated with the retransmission traffic.

17. The method of claim 16, further comprising:
transmitting the buffer status report, subsequent to transmitting the retransmission traffic based at least in part on the first grant, based at least in part on the third configuration;
receiving a third grant for at least a second portion of the retransmission traffic responsive to the buffer status report; and
transmitting the second portion of the retransmission traffic based at least in part on the third grant.

18. The method of claim 14, further comprising:
receiving third control signaling that indicates a third configuration associated with a buffer status report, the third configuration indicating the buffer status report is to report a quantity of retransmission traffic associated with a first logical channel group and a quantity of new traffic associated with a second logical channel group.

19. A non-transitory computer-readable medium storing code for wireless communication, the code comprising instructions executable by one or more processors to:
receive first control signaling that indicates a first configuration for a first scheduling request, the first configuration indicating the first scheduling request is to report an availability of retransmission traffic currently available for transmission;
transmit the first scheduling request indicating the availability of retransmission traffic based at least in part on the first configuration;
receive a first grant for at least a first portion of the retransmission traffic responsive to the first scheduling request; and
transmit the first portion of the retransmission traffic based at least in part on the first grant.

20. The non-transitory computer-readable medium of claim 19, wherein transmitting the first scheduling request is based at least in part on one or more of a duration that the retransmission traffic has been waiting for retransmission, a quantity of unsuccessful transmissions associated with the retransmission traffic, or a quantity of unsuccessful hybrid automatic repeat feedbacks associated with the retransmission traffic.
